(19) United States
(12) Patent Application Publication
(10) Pub. No.: US 2014/0254565 A1
(43) Pub. Date: Sep. 11, 2014

(54) SYSTEMS AND METHODS FOR MULTIPLE CONCURRENT WLAN OPERATIONAL MODES

(71) Applicant: QUALCOMM INCORPORATED, San Diego, CA (US)

(72) Inventors: Vijayaraja Pitchaiah, Chennai (IN); Srinivasan Ganapathy, Chennai (IN); Ramachandran Ranganathan, Chennai (IN)

(73) Assignee: QUALCOMM INCORPORATED, San Diego, CA (US)

(21) Appl. No.: 13/934,126

(22) Filed: Jul. 2, 2013

(30) Foreign Application Priority Data
Mar. 5, 2013 (IN) 669/MUM/2013

(51) Int. Cl. H04L 5/22

(52) U.S. Cl. CPC H04L 5/22
USPC 370/336

(57) ABSTRACT

Systems and methods are provided for enhancing the concurrency of a wireless device operating in multiple network contexts. At least one virtual interface may be implemented for each network context. A recurring communication event having a defined interval associated with one of the network contexts may be identified and the interval may be time divided into multiple operation periods, such that each operation period corresponds to one of the virtual interfaces. Accordingly, each virtual interface may be given access to the physical transceiver during the corresponding operation period. As desired, the operation periods may be subdivided into one or more slots, which may be associated with different priorities of communication.

### FIELD OF THE PRESENT DISCLOSURE

This disclosure generally relates to wireless communication and more particularly to wireless communication devices capable of operating in more than one network context.

### BACKGROUND

The development of multiple communication systems has led to situations where it is desirable to have a single device that is able to participate in multiple network contexts. The term wireless local area network (WLAN) has often meant a network configuration between at least one station and an access point to form a basic service set (BSS) in a standard IEEE 802.11 infrastructure network model. However, the 802.11 wireless transceiver of a given device may be used in numerous other contexts. In one example, two wireless devices may communicate directly without a dedicated management device fulfilling the role of an access point in an ad hoc, peer-to-peer based communication. Other types of direct, peer-to-peer communication include WiFi Direct P2P and others. Further, a given device that may normally operate as station, may also be configured to function as an access point. Additional network configurations are also possible, including Tunneled Direct Link Setup (TDLS) which utilizes direct links between stations through an access point.

Thus, there exists a need for a single wireless device capable of operating in multiple contexts at the same time. The aspect of simultaneous function in multiple contexts may generally be referred to as concurrency. At the most basic, it may be desirable for a single wireless device to maintain a link to two or more independent BSSs, each of which requires its own schedule of communication events in order to maintain the links. However, concurrent operation may also involve a single device participating as one type of network node in a first context and a different type in a second context. For example, a device communicating in one network context as a station may simultaneously establish a peer-to-peer connection with another device or a single device may function as an access point with respect to a first BSS and as a station with respect to a second BSS. As such, it would be desirable for a single physical device to participate in multiple network contexts simultaneously while employing the same physical transceiver.

In order to provide concurrency with a single transceiver, some mechanism must be employed to allow the device to perform at least a minimum number of tasks required to provide operational functionality in each network context. This may include fulfilling at least the minimum exchange of information for operation, such as the requirement for a station to respond to an access point beacon at least once within a given period in order to maintain the link. Similarly, a device acting as an access point may need to transmit beacons with sufficient regularity and respond to requests to maintain a link. In addition, a device may need to perform other tasks to provide proper operation in a given network context, such as channel scanning, device discovery or channel assessment.

Accordingly, what is needed are systems and methods for enhancing the concurrency of a wireless device operating in multiple network contexts while the device is actively connected with one or more other network nodes. This invention satisfies this and other goals.

### SUMMARY

This disclosure is directed to systems and methods for providing concurrency among multiple network contexts using multiple virtual interfaces. For example, a wireless communications device may include a physical transceiver, multiple virtual interfaces operating on different wireless channels using the physical transceiver, and a concurrency manager, wherein the concurrency manager is configured to determine an interval associated with a recurring communication event, perform a time-based division of the interval into multiple operation periods, wherein each operation period is allocated to one of the virtual interfaces, and switch a wireless channel of the physical transceiver for each operation period so that the virtual interface associated with the operation period may communicate using the physical transceiver. Further, the concurrency manager may subdivide at least one of the operation periods into a plurality of slots. In addition, the concurrency manager may associate communications of a given priority with at least one of the plurality of slots. Still further, the concurrency manager may subdivide a first slot in a first operation period to receive a beacon transmission using a first virtual interface. Additionally, the concurrency manager may subdivide a second slot in a second operation period to transmit a beacon transmission using a second virtual interface.

In one aspect, the concurrency manager may send an inactivity signal during a first operation period using a first virtual interface before switching to a wireless channel associated with a second operation period allocated to a second virtual interface. The inactivity signal may be a signal indicating the first virtual interface is entering a power save mode or may be a clear to send to self (CTS-to-Self) frame, a frame having a Quiet Information Element (IE) or a Notice of Absence (NOA) frame.

In another aspect, the concurrency manager may align a first operation period with the recurring communication event. The recurring communication event may be a beacon frame transmission, such as a beacon frame received by one of the virtual interfaces or a beacon frame transmitted by one of the virtual interfaces.

This disclosure also includes methods for providing concurrent wireless communication in multiple network contexts. In one embodiment, a suitable method may include implementing multiple virtual interfaces with a physical transceiver, wherein at least one virtual interface is associated with each network context, determining an interval associated with a recurring communication event of one of the network contexts, performing a time-based division of the interval into multiple operation periods, allocating each operation period to one of the virtual interfaces, and switching a wireless channel of the physical transceiver for each operation period so that the virtual interface associated with the operation period may communicate using the physical transceiver. Further aspects may include subdividing at least one of the operation periods into a plurality of slots. Additionally, communications of a given priority may be associated with at least one of the plurality of slots. A first slot may be subdivided in a first operation period and a beacon transmission received using a first virtual interface during the first slot. Further, a second slot may be subdivided in a second operation period and transmitting a beacon frame using a second virtual interface during the second slot.

In some embodiments, the method may include sending an inactivity signal during a first operation period using a first virtual interface before switching to a wireless channel associated with a second operation period allocated to a second virtual interface. The inactivity signal may be a signal indicating the first virtual interface is entering a power save mode or may be a CTS-to-Self frame, a Quiet IE frame, or a NOA frame.

In another aspect, the method may include aligning a first operation period with the recurring communication event. The recurring communication event may be a beacon frame transmission, such as a beacon frame received by one of the virtual interfaces or a beacon frame transmitted by one of the virtual interfaces.

This disclosure also includes a non-transitory processor-readable storage medium for providing concurrent wireless communication in multiple network contexts, the processor-readable storage medium having instructions thereon, the instructions having code for implementing multiple virtual interfaces with a physical transceiver, wherein at least one virtual interface is associated with each network context, code for determining an interval associated with a recurring communication event of one of the network contexts, code for performing a time-based division of the interval into multiple operation periods, code for allocating each operation period to one of the virtual interfaces, and code for switching a wireless channel of the physical transceiver for each operation period so that the virtual interface associated with the operation period may communicate using the physical transceiver. The storage medium may also include code for subdividing at least one of the operation periods into a plurality of slots. Additionally, the storage medium may include code for associating communications of a given priority with at least one of the plurality of slots. A first slot may be subdivided in a first operation period and the storage medium may include code for receiving a beacon frame using a first virtual interface during the first slot. A second slot may be subdivided in a second operation period and the storage medium may include code for transmitting a beacon frame using a second virtual interface during the second slot.

In one aspect, the storage medium may include code for sending an inactivity signal during a first operation period using a first virtual interface before switching to a wireless channel associated with a second operation period allocated to a second virtual interface. The inactivity signal may be a signal indicating the first virtual interface is entering a power save mode or may be a CTS-to-Self frame, a Quiet IE frame, or a NOA frame.

In another aspect, the storage medium may include code for aligning a first operation period with the recurring communication event. The recurring communication event may be a beacon frame transmission, such as a beacon frame received by one of the virtual interfaces or a beacon frame transmitted by one of the virtual interfaces.

This disclosure may also include a wireless communications device having a physical transceiver, multiple virtual interfaces operating on different wireless channels using the physical transceiver, means for determining an interval associated with a recurring communication event, means for performing a time-based division of the interval into multiple operation periods, wherein each operation period is allocated to one of the virtual interfaces, and means for switching a wireless channel of the physical transceiver for each operation period so that the virtual interface associated with the operation period may communicate using the physical transceiver. The wireless communications device may also include means for subdividing at least one of the operation periods into a plurality of slots. Further, the wireless communications device may include means for associating communications of a given priority with at least one of the plurality of slots. In addition, the means for subdividing may include subdividing a first slot in a first operation period to receive a beacon frame using a first virtual interface or subdividing a second slot in a second operation period to transmit a beacon frame using a second virtual interface.

### BRIEF DESCRIPTION OF THE DRAWINGS

Further features and advantages will become apparent from the following and more particular description of the preferred embodiments, as illustrated in the accompanying drawings, and in which like referenced characters generally refer to the same parts or elements throughout the views, and in which:

FIG. 1 schematically depicts a wireless environment including communication in multiple network contexts, according to one embodiment;

FIG. 2 schematically depicts functional blocks of a wireless communications device configured to provide concurrency between multiple network contexts, according to one embodiment;

FIG. 3 is a schematic representation of a time based division of a recurring communication event interval into multiple operation periods, according to one embodiment;

FIG. 4 is a schematic representation of a time based division of a beacon interval into two operation periods, each having two slots, according to one embodiment;

FIG. 5 is a state diagram showing states associated with switching channels between operation periods, according to one embodiment; and

FIG. 6 is a flowchart showing an exemplary routine for dividing a recurring communication event interval into multiple operation periods for providing concurrency among multiple virtual interfaces, according to one embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein. It is also to be understood that the terminology used herein is for the purpose of describing particular embodiments of this disclosure only and is not intended to be limiting.

The detailed description set forth below in connection with the appended drawings is intended as a description of exemplary embodiments of the present invention and is not intended to represent the only exemplary embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the invention in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed description which follows are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For purposes of convenience and clarity only, directional terms, such as top, bottom, left, right, up, down, over, above, below, beneath, rear, back, and front, may be used with respect to the accompanying drawings or particular embodiments. These and similar directional terms should not be construed to limit the scope of the invention in any manner and may change depending upon context. Further, sequential terms such as first and second may be used to distinguish similar elements, but may be used in other orders or may change also depending upon context.

Embodiments are described herein with regard to a wireless communications device, which may include any suitable type of user equipment, such as a system, subscriber unit, subscriber station, mobile station, mobile wireless terminal, mobile device, node, device, remote station, remote terminal, terminal, wireless communication device, wireless communication apparatus, user agent, or other client devices. Further examples of a wireless communications device include mobile devices such as a cellular telephone, cordless telephone, Session Initiation Protocol (SIP) phone, smart phone, wireless local loop (WLL) station, personal digital assistant (PDA), laptop, handheld communication device, handheld computing device, satellite radio, wireless modem card and/or another processing device for communicating over a wireless system. Moreover, embodiments may also be described herein with regard to an access point (AP). An AP may be utilized for communicating with one or more wireless nodes and may be termed also be called and exhibit functionality associated with a base station, node, Node B, evolved NodeB (eNB) or other suitable network entity. An AP communicates over the air-interface with wireless terminals. The communication may take place through one or more sectors. The AP may act as a router between the wireless terminal and the rest of the access network, which may include an Internet Protocol (IP) network, by converting received air-interface frames to IP packets. The AP may also coordinate management of attributes for the air interface, and may also be the gateway between a wired network and the wireless network.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

As will be described in detail below, this invention is directed to systems and methods for enhancing the concurrency of a wireless device operating in multiple network contexts through the use of more flexible and more frequent opportunity instants that may exist within the normal exchange of information by a device having a single physical transceiver in a first network context. Each network context may be viewed as involving a virtual device supported by a single physical device. In other words, the physical device maintains a plurality of dedicated virtual devices corresponding to each network context. Generally, aspects of this disclosure will be described with respect to a single WLAN transceiver maintaining multiple virtual interfaces, each capable of functioning in a distinct network context. Although described primarily with regard to a single transceiver, the techniques may be applied to applications involving multiple distinct transceivers to further expand their capabilities.

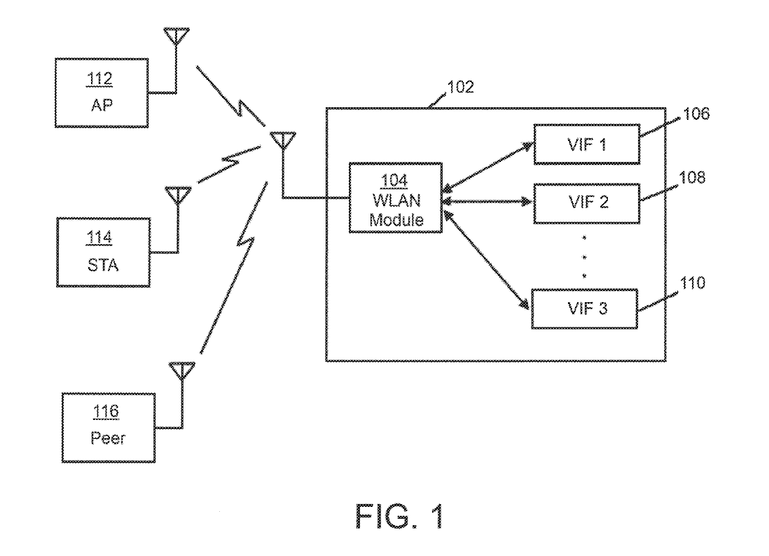

As shown in FIG. 1, an exemplary communication system 100 having multiple network contexts is shown, and may include multimode wireless communications device 102 having a single physical transceiver, WLAN module 104. In this embodiment, WLAN module 104 may be configured for operation under one or more 802.11 protocols. Wireless communications device 102 may participate in multiple network contexts by providing a virtual interface for each context. As shown, a first virtual interface, VIF 1 106, uses WLAN module 104 to exchange information and maintain a communications link with another network node in a first network context. Similarly, second and third virtual interfaces, VIF 2 108 and VIF 3 110, also use WLAN module 104 to maintain links in other network contexts. In the descriptions of this embodiment that follow, VIF 1 106 has been authenticated and is associated with access point (AP) 112 in an infrastructure network context. Any suitable number of additional virtual interfaces may be employed, from one to a plurality, each capable of operating in an independent network context. For example, VIF 2108 may function as an access point, such as a software enabled access point (softAP), for station (STA) 114 and VIF 3 110 may establish a direct peer-to-peer connection with peer 116 in an ad hoc network context.

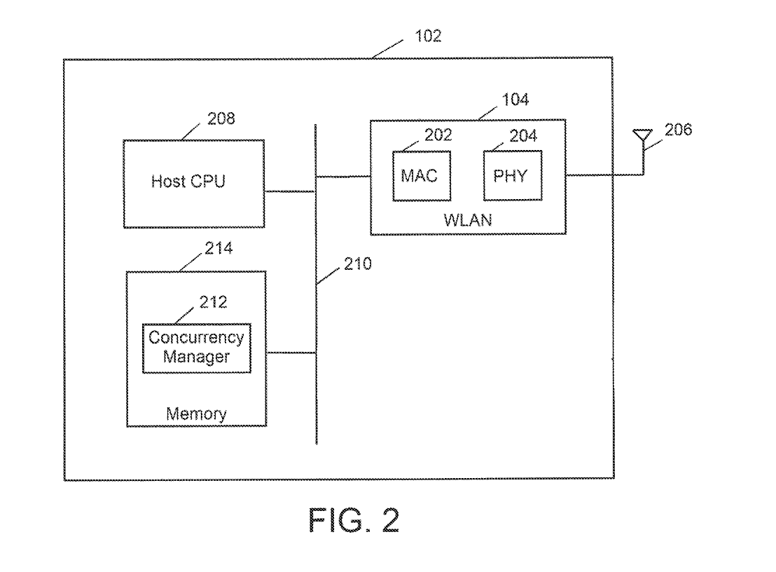

Additional details regarding one embodiment of wireless communications device 102 are depicted as high level schematic blocks in FIG. 2. In some embodiments, wireless communications device 102 may employ an architecture in which the lower levels of the WLAN protocol stack are implemented in firmware and hardware of WLAN module 104. As shown, WLAN module 104 includes media access controller (MAC) 202 that performs functions related to the handling and processing of 802.11 frames of data including verification, acknowledgment, routing, formatting and the like. Incoming and outgoing frames are exchanged between MAC 202 and physical layer (PHY) 204, which as shown here includes the functions of modulating the frames according to the relevant 802.11 protocol as well as providing the analog processing and RF conversion necessary to provide transmission and reception of wireless signals. WLAN module 104 may be coupled to an associated antenna 206. As desired and depending upon the wireless protocols employed, one or more antennas may be shared between the transceivers using switching techniques known in the art. Likewise, some or all elements of the WLAN module 104 may be co-located on a common system, e.g., on the same circuit board or on distinct circuit boards within the same system, or may be embedded on the same integrated circuit as in a system on a chip (SoC) implementation.

Wireless communications device 102 also includes host CPU 208 configured to perform the various computations and operations involved with the functioning of wireless communications device 102. Host CPU 208 is coupled to WLAN module 104 through bus 210, which may be implemented as a peripheral component interconnect express (PCIe) bus, a universal serial bus (USB), a universal asynchronous receiver/transmitter (UART) serial bus, a suitable advanced microcontroller bus architecture (AMBA) interface, a serial digital input output (SDIO) bus, or other equivalent interface.

As shown, wireless communications device 102 may include concurrency manager 212 implemented as processor-readable instructions stored in memory 214 that may be executed by CPU 208 to coordinate operation of WLAN module 104 to implement the virtual interfaces allowing operation in multiple network contexts. According to aspects described below, concurrency manager 212 may be configured to identify a recurring communication event having a defined interval with regard to a first network context and implement a time based division of the defined interval into multiple operation periods, such that each period corresponds to a virtual interface. Accordingly, during each recurring communication interval, each virtual interface may be allocated at least one operation period during which it has access to WLAN module 104. Further, each operation period may be subdivided into one or more slots. In one aspect, each slot may be associated with a desired priority with regard to the types of communication that may be performed during the slot.

By providing one or more operation periods for each virtual interface during each defined interval, communications may be allowed to occur in each network context at a desired degree of regularity and for a desired amount of time. Similarly, by providing one or more slots in each operation period, different amounts of time may be allocated to different types of communication as desired. Further, the allocation of operation periods and slots may be dynamically adjusted to balance desired performance levels among the respective network contexts. For example, the timing and number of slots associated with each operation period may be adjusted. Although embodiments are described in the context of two virtual interfaces, any desired number of virtual interfaces may be supported by providing an operation period for each virtual interface. Likewise, any number of slots may be provided for each operation period to obtain a desired level of performance. Each virtual interface may be associated with one or more operational roles in one or more network contexts, such as operation as an access point, a station or a peer.

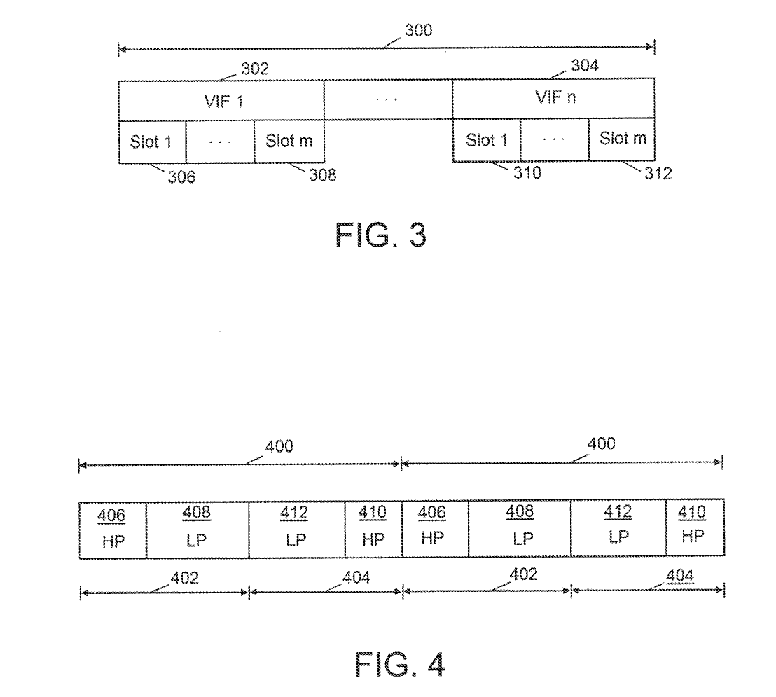

An example of operation period and slot allocation is depicted in FIG. 3. As shown, a recurring communication event interval 300 may be divided into multiple operation periods corresponding to virtual interfaces VIF 1 . . . VIF n, such that one virtual interface may be provided for each network context in which wireless communications device 102 is expected to participate. Here operation period 302 corresponds to VIF 1 and operation period 304 corresponds to VIF n. Further, each operation period may be divided into one or more slots, slot 1 . . . slot m. For example, operation period 302 may be divided into slot 1 306 and slot m 308 while operation period 304 may be divided into slot 1 310 and slot m 312. As discussed below, each slot may be associated with a different priority such that different types of communication with regard to each network context may be performed during each slot. Any suitable number of slots from 1 to m may be employed based on the desired performance and different operation periods may have different numbers m of slots.

A further example of operation period and slot allocation in the context of wireless communications device 102 maintaining communications links with AP 112 and STA 114 is shown in FIG. 4. In this embodiment, the recurring communication event may be the broadcast of a beacon frame by AP 112. Accordingly, concurrency manager 212 may divide beacon intervals 400 of AP 112, which may be 100 ms or other suitable duration, into operation periods 402 and operation periods 404. Each operation period 402 may be allocated to VIF 1 106 to communicate with AP 112 while each operation period 404 may be allocated to VIF 2 108 to communicate with STA 114. Further, each operation period 402 may be subdivided into high priority (HP) slots 406 and low priority (LP) slots 408 and each operation period 404 may be subdivided into HP slots 410 and LP slots 412. In other embodiments, the recurring communication event may be the transmission of a beacon frame by VIF 2 108, for example.

As indicated, different types of communication may be performed during the HP and LP slots. For example, VIF 1 106, acting in a network context role of a station in an infrastructure network associated with AP 112, may use HP slots 406 to receive beacon transmissions and may use LP slots 408 to exchange data. Similarly, VIF 2 108, acting in a network context role of an access point, such as a SoftAP, managing an infrastructure network having STA 114 as an associated station (as well as other stations as desired, which are not shown in FIG. 1 for the purpose of clarity), may use HP slots 410 to broadcast beacon frames and may use LP slots 412 to exchange data.

In one embodiment, HP slots 406 and 410 may have a duration of 20 ms and LP slots 408 and 412 may have a duration of 30 ms when the recurring communication event has a beacon interval of 100 ms. These values are given as examples only and may be adjusted as desired, depending upon the number of virtual interfaces implemented and other suitable criteria. In one embodiment, slots initially allocated to one virtual interface may be dynamically reassigned to another virtual interface, depending on use conditions. For example, if concurrency manager 212 determines VIF 2 108 has no pending data to exchange or other low priority communications, one or more LP slots 412 may be reassigned to VIF 1 106.

Different types of communication may be assigned to slots of different priority in order to achieve a desired level of performance. In one embodiment, high priority slots may be assigned to communications associated with the synchronization and operation of the respective network. For example, beacon transmissions and receptions may be categorized as high priority communications. Further, low priority slots may be assigned to asynchronous communication or communication that is capable of being retransmitted, such as data exchange. Other types of communication may also be associated with a desired priority level. For example, WLAN scanning operations may be associated with a medium priority level. Alternatively, WLAN scanning operations may be associated with a low priority level such that low priority slots may be used for a scanning operation when not needed for data exchange or other low priority communications.

In another aspect, it may be desirable to align any operation periods with regard to each network context. For example, beacon frames are transmitted by AP 112 at predetermined intervals. Accordingly, operation periods such as operation period 402 and HP slot 406 may be aligned to corresponds to the target beacon transmission time (TBTT) communicated by AP 112. Further, concurrency manager 212 may be configured to account for delays associated with switching channels or timing inaccuracies when establishing the operation periods. For example, operation period 402 may be assigned to help ensure that WLAN module 104 has completed the channel switch and is ready to receive a scheduled beacon transmission from AP 112.

When transitioning from one operation period to another, WLAN module 104 may switch wireless channels as each virtual interface may operate on a different channel. To minimize disruption to each network context when switching channels, concurrency manager 212 may be configured to signal a period of inactivity in a network context corresponding to each operation period that is not assigned to that network context. Any suitable manner of signaling may be employed to communicate to other nodes in each network context the. Further, the manner of signaling the period of inactivity may depend upon the network context. Still further, any combination of inactive signals may be used.

In one embodiment, wireless communications device 102 may employ VIF 1 106 to operate in the role of a station with regard to AP 112. In order to communicate periods of inactivity corresponding to operation periods not allocated to VIF 1 106, concurrency manager 212 may employ a suitable power save messaging protocol. Using techniques appropriate to the wireless protocol, VIF 1 106 may signal that it is entering power save mode so that AP 112 buffers upcoming transmissions and does not expect communication with VIF 1 106 until a signal is sent that VIF 1 106 is exiting power save mode. For example, VIF 1 106 may send a frame having the power management (PM) bit set to indicate it is entering power save mode. Correspondingly, AP 112 will buffer upcoming traffic for wireless communications device 102 until it receives a frame having an unset PM bit. Similarly, VIF 1 106 may buffer any traffic for AP 112 until a subsequent operation period is allocated to it.

In other embodiments, wireless communications device 102 may employ VIF 2 108 to operate in the role of an access point to STA 114. In order to communicate periods of inactivity corresponding to operation periods not allocated to VIF 2 108, concurrency manager 212 may employ a suitable inactivity signal.

In one aspect, concurrency manager 212 may be configured to use VIF 2 108 to transmit a clear to send to self (CTS-to-Self) frame to suppress communications during operation periods not allocated to VIF 2 108. Depending on the wireless protocol, the amount of time that may be signaled using a CTS-to-Self may be limited to a defined period of time, such as approximately 32 ms. As such, concurrency manager 212 may be configured to assign operation periods in a manner consistent with this time period. For example, operation periods may be allocated to VIF 2 108 with at least the frequency associated with the CTS-to-Self time period, so that VIF 2 108 may properly signal periods of inactivity in that network context.

In another aspect, concurrency manager 212 may be configured to use VIF 2 108 to transmit a frame having a quiet information element (IE). The Quiet IE may be used to signal periods of inactivity to associated clients that are capable of recognizing this IE, such as clients conforming to 802.11a standards. In yet another aspect, concurrency manager 212 may be configured to use VIF 3 110 to transmit a Notice of Absence (NOA) frame to peer to peer (P2P) clients to signal periods of inactivity corresponding to operation periods not assigned to VIF 3 110.

As noted, any combination of inactivity signaling mechanisms may be employed as desired, including indications of power save mode entry or exit, CTS-to-Self frames, Quiet IE frames, NOA frames, and any other suitable signal for alerting a connected network node that communications associated with one of the virtual interfaces of wireless communications device 102 may be suspended for a period of time.

By using the techniques of this disclosure, the maximum throughput available over WLAN module 104 may be distributed among the multiple virtual interfaces as desired. Throughput may be shared and apportioned by the relative durations of the operation periods. The theoretical maximum throughput may be reduced by overhead associated with switching channels. For example, a channel switch delay of approximately 1.5 ms and a processing delay of approximately 1 ms may be incurred at each switch. In other embodiments, different delays may be incurred. In one aspect, the number of operation periods employed by concurrency manager 212 may be adjusted to accommodate and reduce the overhead associated with such delays.

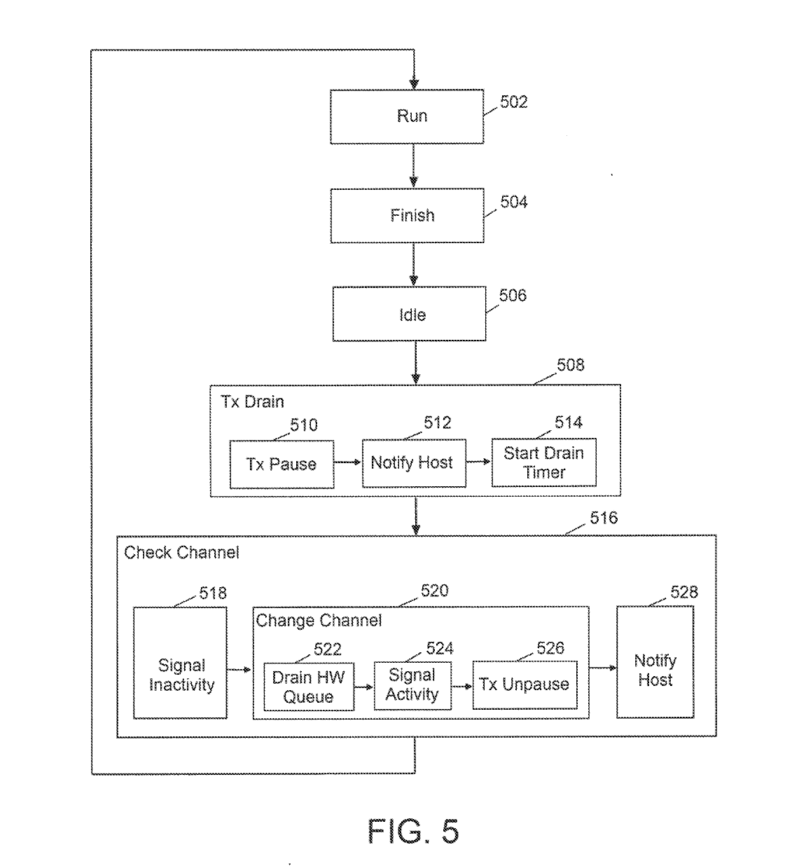

When switching channels, WLAN module 104 may be configured to pause any hardware queues associated with the current channel, allowing the queues to drain and flush all pending packets before switching channels. After switching channels, any hardware queues may be un paused. One suitable implementation for managing queues during a channel switching event is represented by the state machine depicted in FIG. 5. As shown, run state 502 may occur after a successful channel switch and may be associated with an operation period assigned to a virtual interface by concurrency manager 212. At the end of the operation period, or slot, any final communications may occur in finish state 504 and transition to idle state 506 in preparation for a channel switch. As indicated, transmission (Tx) drain state 508 may include sequential operations such as pausing transmission with WLAN module 104 in state 510, notifying host CPU 208 to buffer communications in state 512 and starting a drain timer in state 514. Next, a check channel state 516 may include signaling inactivity in the current channel in state 518. A change channel state 520 may follow, including draining the hardware transmission queue in state 522. The drain timer of state 514 may be set based on the status of the hardware queue. Following state 522, WLAN module 104 may switch channels and signal activity on the new channel in state 524. The change channel state 520 may then include unpausing transmission with regard to network context operation on the new channel. After the change channel state 520 is completed, state 528 may include notifying host CPU 208 that the virtual interface operating on the new channel has access to WLAN module 104. This places WLAN module 104 in the run state 502, so that communications during the operation period may be performed. The operations associated with the state machine of FIG. 5 may be implemented using any desired combination of hardware, software or firmware.

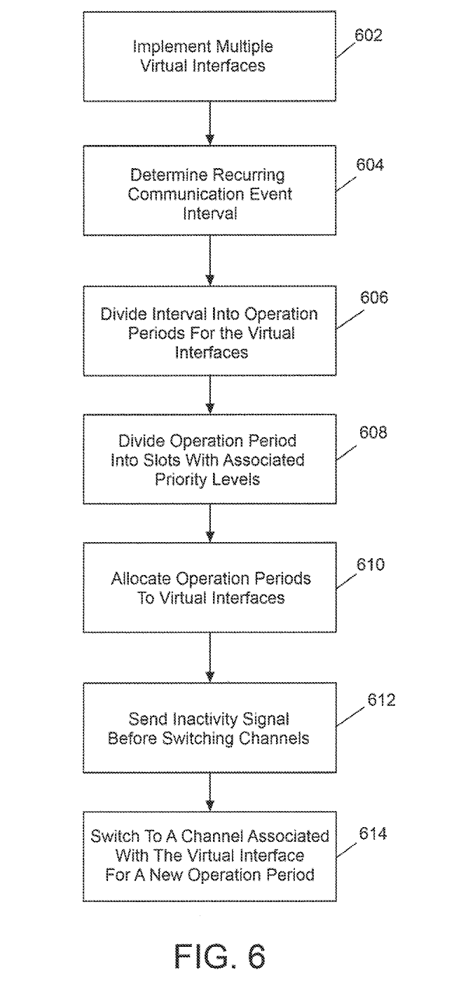

To help illustrate the techniques of this disclosure with regard to implementing a time based division of a recurring communication event interval into multiple operation periods, such that each operation period corresponds to a virtual interface, an exemplary routine is represented by the flowchart of FIG. 6. Beginning with step 602, wireless communications device 102 may implement multiple virtual interfaces, such as VIF 1 106, VIF 2 108 and VIF 3 110, for operation using WLAN module 104. As described above, each virtual interface may be associated with operation in a different network context. Next, concurrency manager 212 may determine an interval associated with a recurring communication event of one of the network contexts in step 604. Concurrency manager 212 may then provide a time-based division of the interval into multiple operation periods as indicated by step 606. Additionally, one or more operation periods may be subdivided into one or more slots, wherein each slot may be associated with a different priority of communications in step 608. In step 610, concurrency manager 212 may allocate each operation period to one of the virtual interfaces. Prior to switching channels when transitioning from one operation period to another, concurrency manager 212 may send an inactivity signal on the current channel as indicated by step 612. As desired, concurrency manager 212 may also signal host CPU 208 to pause the transmission queue and buffer data for the current channel. Concurrency manager 212 may then switch the wireless channel of WLAN module 104 when transitioning to a new operation period so that the virtual interface associated with the operation period may communicate using WLAN module 104 in step 614. As desired, concurrency manager 212 may also signal host CPU 208 to unpause the transmission queue and release any buffered data associated with the virtual interface using the new channel.

Described herein are presently preferred embodiments. However, one skilled in the art that pertains to the present invention will understand that the principles of this disclosure can be extended easily with appropriate modification. For example, the techniques may be applied to wireless communications devices having multiple transceivers or that support communications across multiple frequency bands using one MAC.

What is claimed is:

1. A wireless communications device comprising a physical transceiver, multiple virtual interfaces operating on different wireless channels using the physical transceiver, and a concurrency manager, wherein the concurrency manager to:
determine an interval associated with a recurring communication event;
perform a time-based division of the interval into multiple operation periods, wherein each operation period is allocated to one of the virtual interfaces; and
switch a wireless channel of the physical transceiver for at least one operation period so that the virtual interface associated with the operation period may communicate using the physical transceiver.

2. The wireless communications device of claim 1, wherein the concurrency manager further to subdivide at least one of the operation periods into a plurality of slots.

3. The wireless communications device of claim 2, wherein the concurrency manager further to associate communications of a given priority with at least one of the plurality of slots.

4. The wireless communications device of claim 3, wherein the concurrency manager further to subdivide a first slot in a first operation period to receive a beacon frame using a first virtual interface.

5. The wireless communications device of claim 4, wherein the concurrency manager further to subdivide a second slot in a second operation period to transmit a beacon frame using a second virtual interface.

6. The wireless communications device of claim 1, wherein the concurrency manager further to send an inactivity signal during a first operation period using a first virtual interface before switching to a wireless channel associated with a second operation period allocated to a second virtual interface.

7. The wireless communications device of claim 6, wherein the inactivity signal comprises a signal indicating the first virtual interface is entering a power save mode.

8. The wireless communications device of claim 6, wherein the inactivity signal is one of the group consisting of a clear to send to self (CTS-to-Self) frame, a frame having a Quiet Information Element (IE) and a Notice of Absence (NOA) frame.

9. The wireless communications device of claim 1, wherein the concurrency manager to align a first operation period with the recurring communication event.

10. The wireless communications device of claim 9, wherein the recurring communication event comprises a beacon frame transmission.

11. A method for providing concurrent wireless communication in multiple network contexts, comprising:
implementing multiple virtual interfaces with a physical transceiver, wherein at least one virtual interface is associated with each network context;
determining an interval associated with a recurring communication event of one of the network contexts;
performing a time-based division of the interval into multiple operation periods;
allocating each operation period to one of the virtual interfaces; and
switching a wireless channel of the physical transceiver for each operation period so that the virtual interface associated with the operation period may communicate using the physical transceiver.

12. The method of claim 11, further comprising subdividing at least one of the operation periods into a plurality of slots.

13. The method of claim 12, further comprising associating communications of a given priority with at least one of the plurality of slots.

14. The method of claim 13, wherein the subdividing comprises subdividing a first slot in a first operation period, further comprising receiving a beacon frame using a first virtual interface during the first slot.

15. The method of claim 14, wherein the subdividing comprises subdividing a second slot in a second operation period, further comprising transmitting a beacon frame using a second virtual interface during the second slot.

16. The method of claim 11, further comprising sending an inactivity signal during a first operation period using a first virtual interface before switching to a wireless channel associated with a second operation period allocated to a second virtual interface.

17. The method of claim 16, wherein the inactivity signal comprises a signal indicating the first virtual interface is entering a power save mode.

18. The method of claim 16, wherein the inactivity signal is one of the group consisting of a clear to send to self (CTS-to-Self) frame, a frame having a Quiet Information Element (IE) and a Notice of Absence (NOA) frame.

19. The method of claim 11, further comprising aligning a first operation period with the recurring communication event.

20. The method of claim 19, wherein the recurring communication event comprises a beacon frame transmission.

21. A non-transitory processor-readable storage medium for providing concurrent wireless communication in multiple network contexts, the processor-readable storage medium having instructions thereon, the instructions comprising:
code for implementing multiple virtual interfaces with a physical transceiver, wherein at least one virtual interface is associated with each network context;
code for determining an interval associated with a recurring communication event of one of the network contexts;
code for performing a time-based division of the interval into multiple operation periods;
code for allocating each operation period to one of the virtual interfaces; and
code for switching a wireless channel of the physical transceiver for each operation period so that the virtual interface associated with the operation period may communicate using the physical transceiver.

22. The non-transitory processor-readable storage medium of claim 21, further comprising code for subdividing at least one of the operation periods into a plurality of slots.

23. The non-transitory processor-readable storage medium of claim 22, further comprising code for associating communications of a given priority with at least one of the plurality of slots.

24. The non-transitory processor-readable storage medium of claim 23, wherein the code for subdividing comprises code for subdividing a first slot in a first operation period, further comprising receiving a beacon frame using a first virtual interface during the first slot.

25. The non-transitory processor-readable storage medium of claim 24, wherein the code for subdividing comprises code for subdividing a second slot in a second operation period, further comprising transmitting a beacon frame using a second virtual interface during the second slot.

26. The non-transitory processor-readable storage medium of claim 21, further comprising code for sending an inactivity signal during a first operation period using a first virtual interface before switching to a wireless channel associated with a second operation period allocated to a second virtual interface.

27. The non-transitory processor-readable storage medium of claim 26, wherein the inactivity signal comprises a signal indicating the first virtual interface is entering a power save mode.

28. The non-transitory processor-readable storage medium of claim 26, wherein the inactivity signal is one of the group consisting of a clear to send to self (CTS-to-Self) frame, a frame having a Quiet Information Element (IE) and a Notice of Absence (NoA) frame.

29. The non-transitory processor-readable storage medium of claim 21, further comprising code for aligning a first operation period with the recurring communication event.

30. The non-transitory processor-readable storage medium of claim 29, wherein the recurring communication event comprises a beacon frame transmission.

31. A wireless communications device comprising:
a physical transceiver;
multiple virtual interfaces operating on different wireless channels using the physical transceiver,
means for determining an interval associated with a recurring communication event;
means for performing a time-based division of the interval into multiple operation periods, wherein each operation period is allocated to one of the virtual interfaces; and
means for switching a wireless channel of the physical transceiver for each operation period so that the virtual interface associated with the operation period may communicate using the physical transceiver.

32. The wireless communications device of claim 31, further comprising means for subdividing at least one of the operation periods into a plurality of slots.

33. The wireless communications device of claim 32, further comprising means for associating communications of a given priority with at least one of the plurality of slots.

34. The wireless communications device of claim 33, further comprising means for subdividing a first slot in a first operation period to receive a beacon frame using a first virtual interface.

35. The wireless communications device of claim 34, further comprising means for subdividing a second slot in a second operation period to transmit a beacon frame using a second virtual interface.
